(19) United States
(12) Patent Application Publication
(10) Pub. No.: US 2011/0231213 A1
(43) Pub. Date: Sep. 22, 2011

(54) METHODS AND SYSTEMS OF DETERMINING THE EFFECTIVENESS OF CAPITAL IMPROVEMENT PROJECTS

(75) Inventors: Roger N. Anderson, New York, NY (US); Albert Boulanger, New York, NY (US); Samantha Cook, New York, NY (US); John Johnson, Belle Harbor, NY (US)

(73) Assignee: THE TRUSTEES OF COLUMBIA UNIVERSITY IN THE CITY OF NEW YORK, New York, NY (US)

(21) Appl. No.: 12/885,800

(22) Filed: Sep. 20, 2010

Related U.S. Application Data
(63) Continuation of application No. PCT/US2009/037996, filed on Mar. 23, 2009.
(60) Provisional application No. 61/038,648, filed on Mar. 21, 2008.
(60) Provisional application No. 61/154,294, filed on Feb. 20, 2009.

(51) Int. Cl. G06Q 10/00

(52) U.S. Cl. 705/7.11

(57) ABSTRACT

The present application provides methods and systems for quantitatively predicting an effectiveness of a proposed capital improvement project based on one or more previous capital improvement projects representative of one or more physical assets and including one or more attributes that includes defining a first sample pool from the previous capital improvement project data in which said previous capital improvement project has been performed, defining a second sample in which the previous capital improvement project has not been performed, the second sample pool including one or more attribute values that are the same as, or similar to, the attribute values for the first sample pool, generating a performance metric for each of the first and second sample pools, comparing the performance metric from the first sample pool with the performance metric from the second sample pool to determine a net performance metric, and, generating a prediction of effectiveness of the proposed capital improvement project concerning based on said net performance metric.

### CROSS-REFERENCE TO RELATED APPLICATIONS

This application claims priority from U.S. Provisional Application Ser. No. 61/038,648 filed on Mar. 21, 2008, and U.S. Provisional Application Ser. No. 61/154,294, filed Feb. 20, 2009, the entirety of each of the disclosures of which are explicitly incorporated by reference herein.

### COPYRIGHT NOTICE

A portion of the disclosure of this patent document contains material which is subject to copyright protection. The copyright owner has no objection to the facsimile reproduction by any one of the patent disclosure, as it appears in the Patent and Trademark Office patent files or records, but otherwise reserves all copyright rights whatsoever.

### FIELD

The disclosed subject matter relates to techniques for determining the benefits of a capital improvement project.

### BACKGROUND

To determine if the cost of a proposed capital improvement project is justified, it is helpful to observe the performance of equipment, assets or other instrumentalities in which the proposed capital improvement has already been performed. Knowledge of process gains achieved upon performing the capital improvement project is helpful in determining whether the capital improvement should be repeated in other areas of operation.

Oftentimes, however, it is misleading to compare the performance of an “improved” piece of equipment or instrumentality with a “non-improved” equipment or instrumentality, as other, non-related factors can be contributing to gains or reductions in productivity. This is particularly the case, for example, in the setting of an electrical grid, in which a multitude of external factors contributes to the performance of components within the electrical grid.

Accordingly, upon selection of an “improved” piece of equipment or instrumentality, there remains a need to determine a proper “twin,” in which the contribution of unrelated factors for each sample set are constant, thus isolating the impact of the capital improvement.

### SUMMARY

The present application provides methods and systems for determining the effectiveness of proposed capital improvement projects by careful selection of a control group in which the performance of a previously performed capital improvement project is measured against.

One aspect of the present application provides a method of quantitatively predicting an effectiveness of a proposed capital improvement project based on one or more previous capital improvement projects. The method includes defining a first sample pool from the previous capital improvement project data in which the capital improvement project has been performed. According to this aspect of the application, a second sample pool is also defined, in which the previous capital improvement project has not been performed. The second sample pool includes one or more attribute values that are the same as, or similar to, the attribute values for the first sample pool. The method also includes generating a performance metric for the first and second sample pools, and comparing the performance metric from the first sample pool with the performance metric from the second sample pool in order to determine a net performance metric. Finally, the method includes generating a prediction of effectiveness of the proposed capital improvement project based the net performance metric determined above.

One aspect of the present application also provides a system for quantitatively predicting the effectiveness of a proposed capital improvement project based on one or more previous capital improvement projects. The system includes one or more processors, each having respective communication interfaces to receive data concerning (1) one or more previous capital improvement projects and (2) data representative of physical assets in which the capital improvement project has not been performed. Further, the system includes one or more software applications, operatively coupled to the one or more processors, to define a first and second sample pool. The first sample pool is from data taken from capital improvement projects already performed and includes one or more attribute values. The second sample pool is taken from data in which capital improvement projects has not been performed, and includes attribute values that are the same as, or similar to, the attribute values for the first sample pool. The software also generates a performance metric for each of the first and second sample pools and compares these performance metrics to determine a net performance metric. Finally the system generates a prediction of effectiveness of the proposed capital improvement project based on the net performance metric. The system also includes a display, coupled to the one or more processors, for visually presenting the prediction of effectiveness.

One aspect of the present application also provides a computer-readable medium that includes a software component that, when executed, performs a method of quantitatively predicting an effectiveness of a proposed capital improvement project. The software component defines a first sample pool from the previous capital improvement project data in which the previous capital improvement project has been performed. The software component also defines a second sample pool in which the previous capital improvement project has not been performed. The second sample pool includes one or more attribute values that are the same as, or similar to, the attribute values for the first sample pool. The software component generates a performance metric for each of the first and second sample pools and compares the performance metric from the first sample pool with the performance metric from the second sample pool to determine a net performance metric. The software component also generates a prediction of effectiveness of the proposed capital improvement project based on the net performance metric.

### BRIEF DESCRIPTION OF THE DRAWINGS

Further objects, features and advantages of the disclosed subject matter will become apparent from the following detailed description taken in conjunction with the accompanying figures showing illustrative embodiments of the disclosed subject matter, in which:

FIG. 1 depicts a flow diagram of an exemplary system of the present application that can be used to determine the effectiveness of capital improvement projects.

FIG. 2 is a plot of the percentage of Feeders within “buckets” that had a specified number of open auto outages as described in Example 1 below. Buckets were created based on a similar percentage of stop joints present in the feeders.

FIG. 3 is a histogram of the pre-selected attributes (average shifted load, load pocket weight and total joint count) for the “pure” test group and the “impure” control group. By having a similar distribution of attributes, the effect of the purification efforts in the “pure” group can be isolated and determined.

FIG. 4 is a histogram of summer 2005 O/A outages (left) and trouble outages (right) on the pure feeders in Brooklyn and Queens (top) compared to the control group of impure feeders (bottom).

While the disclosed subject matter will now be described in detail with reference to the figures, it is done so in connection with the illustrative embodiments.

### DETAILED DESCRIPTION

The present disclosure is based on the use of statistical methods to obtain a control group that has similar attributes to a sample set in which a capital improvement project has already been performed. By selecting a control group having similar attributes, other factors which can independently affect the performance of the process at issue are accounted for, and the effect of the capital improvement project can be isolated.

Such information reveals the effectiveness of prior capital improvement projects, and is helpful in determining which capital improvement projects should receive priority in the future. For example, the methods of the present application can be used to prove that previously performed capital improvement projects were effective and to help dictate policy going forward with respect to such efforts. The methods of the present invention can also be used to shape expectations for proposed capital improvement policies, or to perform a cost benefit analysis of performed capital improvement policies to determine if the savings or productions increases achieved upon performing the desired improvements justify the costs of implementing the capital improvement project.

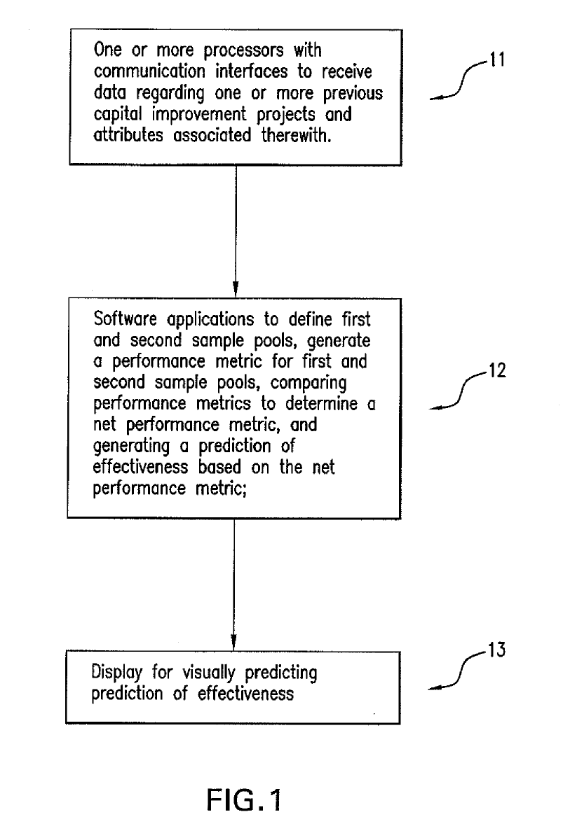

Referring to FIG. 1, an exemplary system (10) to determine the effectiveness of a proposed capital improvement project will be described. As shown, one or more processors (11) is provided with communication interfaces to receive data regarding one or more previous capital improvement projects and attributes associated therewith. The data can be entered into the processor, and thus received, automatically from electronically-maintained system records, or the data may be manually entered into the processor. A software application (12) is provided (e.g. “R” or “MatchIt” software applications) that is operatively coupled to the one or more processors. The software application, based on data received from the processor, defines a first and second sample pools, generates a net performance metric based on the performance metrics of the first and second data pools and makes a prediction of the effectiveness of the proposed capital improvement project based on the net performance metric. The system also contains a display (13), such as a computer monitor, for visually predicting the effectiveness of the proposed capital improvement project.

The methods of the presently disclosed subject matter are particularly useful in production facilities in which a large number of capital improvement projects have been performed in the past. One particular application for the methods of the present application is an electrical grid, since, generally, there is a large source of available data regarding infrastructure in which various capital improvement projects have already been implemented.

While the application is described largely in the context of a capital improvement project within an electrical grid (e.g. replacing stop joints and PILC cable sections in electrical feeders), it is important to note that it is equally applicable to a wide range of processes, including but not limited to, chemical processing operations, product manufacturing operations and telecommunication, transportation, civil, gas, pipeline, storage, steam, water, sewer, and other utility infrastructure projects. So long as there is a quantifiable performance metric associated with the capital improvement and one or more attributes that also affect the performance metric (besides the capital improvement project itself), the methods of the present application can be used to isolate the benefits of the capital improvement project.

As used herein the term “attribute” refers to the variables which are inputted into the particular statistical analysis technique (e.g. propensity scoring) by which the first sample pool that represents the asset, equipment or other instrumentality in which the desired capital improvement project has been performed, and the second “control” sample pool are related. The attribute(s) should be a variable that affects the same performance metric as that to which the capital improvement project is directed to. Upon performing the statistical analysis technique, a control group can be identified that has the same (or similar) attribute value(s) as the group representing the sample in which the capital improvement project has been performed.

In the context of an electrical grid, the performance metric can be, for example, based on the failure (or non-failure) of the component under investigation. Attributes are selected that also impact whether or not the component of the electrical grid fails. In this particular context, attributes can be obtained, for example, based on the results of a “marti-ranking” machine learning algorithm disclosed in International Published Application No. WO 2007/087537, which is hereby incorporated by reference in its entirety.

When a feeder fails, its substation protection circuitry will isolate if from its power supply in the substation automatically, which is know in the art as an “open auto” or “O/A.” In one embodiment, the attribute value is the number of O/A failures of the feeder under investigation for specified time period. In another embodiment, the attribute is the number of all outages except planned non-emergency outages. For example, the attribute value in one embodiment can be the number of O/A outages, “fail on test” outages (“FOT”), failure open initial energization or “cut-in open auto” (“CIOA failure”), and “out on emergency” outage (“OOE”).

### Statistical Methods to Relate Data

Various methodologies, known to persons skilled in the statistical arts, exist that can match test data (i.e. data representative of a sample in which the capital improvement has been performed) with control data such that casual effects besides the capital improvement project are mitigated. These methods seek to arrive at a result in which the two data sets have approximately the same distribution of attributes.

In certain embodiments, propensity scoring is used to correlate the test data with the control data. As used herein, propensity scores refer to the well known algorithm introduced by Rosenbaum and Rubin: Rosenbaum, P. R. and Rubin, D. B., “The central Role of the Propensity Score in Observational Studies for Causal Effects,” Biometrika, Vol. 70, pp. 41-55 (1983), which is hereby incorporated by reference.

Formally, propensity scores for subject i (i=1, . . . , N) as the conditional probability of assignment to particular treatment (Zᵢ=1) versus control (Zᵢ=0) given a vector of observed covariates, xᵢ, as shown in equation (1):

e(xᵢ)=pr(Zᵢ=1|Xᵢ=xᵢ) (1)

where it is assumed that, given the X's the Zᵢ are independent:

pr(Z1=zi, . . . , Z=zₙ|X₁=xᵢ, . . . , X_{N}=x_{N})=Π(from i=1 to n)e(xᵢ)^{zi}{1−e(xᵢ)}^{1-zi}. (2)

The propensity score is the ‘coarsest function’ of the covariates that is a balancing score, where a balancing score, b(X), is defined as ‘a function of the observed covariates X such that the conditional distribution of X given (bX) is the same for treated (Z=1) and control (Z=0) units. For a specific value of the propensity score, the difference between the treatment and control means for all units with that value of the propensity score is an unbiased estimate of the average treatment effect at that propensity score, if the treatment assignment is strongly ignorable, given the covariates. Thus, matching, stratification, or regression (covariance) adjustment on the propensity score tends to produce unbiased estimates of the treatment effects when treatment assignment is strongly ignorable. Treatment assignment is considered strongly ignorable if the treatment assignment, Z, and the response, Y, are known to be conditionally independent given the covariates, X (that is, when Y¹−Z|X).

When covariates contain no missing data, the propensity score can be estimated using discriminant analysis or logistic regression. Both of these techniques lead to estimates of probabilities of treatment assignment conditional on observed covariates. Formally, the observed covariates are assumed to have a multivariate normal distribution (conditional on Z) when discriminant analysis is used, whereas this assumption is not needed for logistic regression.

Other statistical techniques for finding similarly matched data sets can be employed, such as, for example, Levenshtein, Euclidean, Manhattan, Mahalanobis, Chebychev, Spearman, and Pearson Correlation coefficient, or other distance metrics. Other techniques are disclosed in Chapters 9 and 10 of “Data Analysis Using Regression and Multilevel/Hierarchical Models, A. Gelman and J. Hill, Cambridge University Press; 1 ed. (Dec. 18, 2006), available at www.stat.columbia.edu/˜gelman/arm/chap9.pdf and http://www.stat.columbia.edu/˜gelman/arm/chap10.pdf. This entire book is hereby incorporated by reference in its entirety.

Statistical software applications and programs are available which can assist person of ordinary skill in the art in using similar matching algorithms, such as propensity scoring. Examples of such software include “R,” available at http://www.r-project.org and “MatchIt,” which is a program available for R and available at http://gking.harvard.edu/matchit/. See also, Gelman et al., “Data Analysis Using Regression and Multilevel/Hierarchical Models”, Section 10.8, pp. 229-231.

A client computer and a server computer are used in some embodiments to implement the programs described above. Software modules can run a on a computer, one or more processors, or a network of interconnected processors and/or computers each having respective communication interfaces to receive and transmit data. Alternatively, the software modules can be stored on any suitable computer-readable medium, such as a hard disk, a USB flash drive, DVD-ROM, optical disk or otherwise. The processors and/or computers can communicate through TCP, UDP, or any other suitable protocol. Conveniently, each module is software-implemented and stored in random-access memory of a suitable computer, e.g., a work-station computer. The software can be in the form of executable object code, obtained, e.g., by compiling from source code. Source code interpretation is not precluded. Source code can be in the form of sequence-controlled instructions as in Fortran, Pascal or “C”, for example.

Various modifications and alterations to the described embodiments will be apparent to those skilled in the art in view of the teachings herein. For example, the program described above can be hardware, such as firmware or VLSICs, that communicate via a suitable connection, such as one or more buses, with one or more memory devices.

### Example

### Analysis of Benefits of Feeder Purification Efforts

A methodology was developed for testing the hypothesis that “purifying” 27 kV electrical feeders within an electrical grid by replacing most of the PILC sections and stop joints in them with all new cable and joints (<5% stop joints) will result in fewer feeder outages and thus enhance reliability. Feeder outages were defined to include both O/A (open auto outages) events and any non-scheduled outages.

Outage history from primary feeders for all network feeders were compared and classified (“binned into buckets”) based on the number of stop joints. Stop Joint Buckets were established for feeders with 0-5% stop joints, 5-10% stop joints, 10-15% stop joints, 15-20% stop joints, 20-25% stop joints, 25-30% stop joints, 30-35% stop joints, and 35-40% stop joints. Primary feeders with 0-5% feeders were deemed to be “pure” feeders.

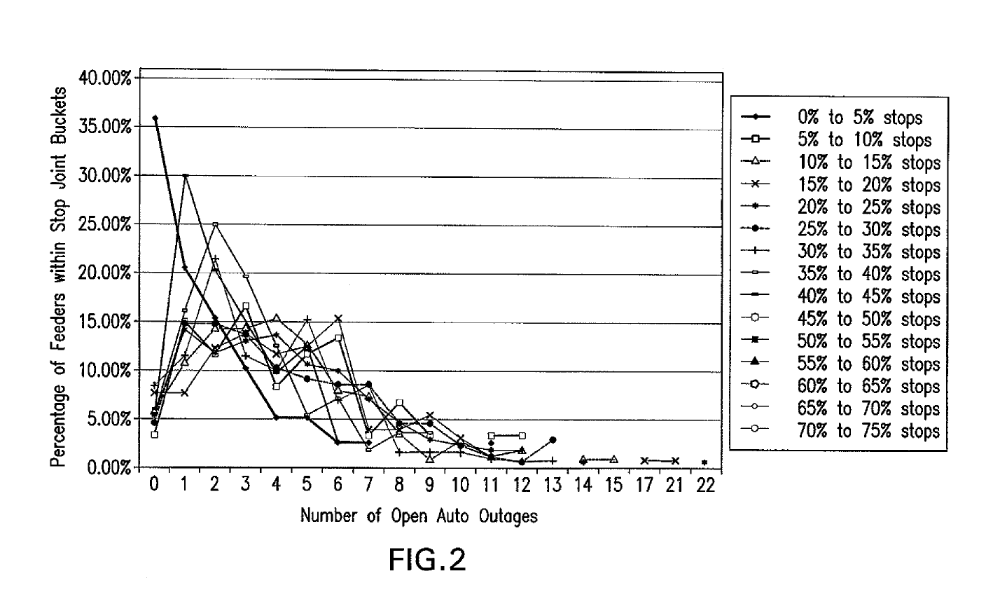

The number of O/A outages since 2001 was determined for each feeder, and the percentage of those feeders within each bucket having a specified number of O/A outages was plotted. Whereas about 35% of the feeders in the 0-5% stop joint bucket, i.e. 35% of “pure” feeders, did not have any O/A outages, buckets with a higher percentage of stop joints had more failures. The remaining results are shown in FIG. 2, in which the percentage of feeders in the particular “buckets” is plotted against the number of O/A failures.

Whereas the preliminary investigation in the above paragraph and FIG. 2 suggests that purified feeders perform better (i.e. do not have as many failures), this was not statistically certain. For example, there can be other factors, unrelated to feeder purity, that are disproportionately affecting the feeders with higher numbers of stop joints. Propensity scores were employed to find non-pure “twins” of the feeders classified as “pure” in order to remove, or at least downplay, the contribution any factors besides the number of stop joints.

In order to determine propensity scores, three attributes were identified that, besides feeder purity, were deemed most relevant to feeder failure. Load Pocket Weight (LPW), Shifted Load Factor and Total Number of Joints (of all kinds) were selected as the attributes for which the propensity scores were to be based in order to find non-pure “twins” that had a comparable number of sections, having similar impedance relationships to other feeders in their networks and have similar load stress on the secondary neighborhood they supply. These attributes were determined using attributes selected most often by a marti-ranking machine learning algorithm used to predict impending feeder open auto outages (see, e.g., International Published Application No. WO 2007/087537, which is hereby incorporated by reference). Characteristics for each attribute are discussed below in Table 1.

TABLE 1
Attributes selected for Propensity Scoring

| Attribute Name | Meaning |
|---|---|
| Load Pocket Weight | Daily summed load pocket weights for the |
| | feeder averaged over the summer months |
| | (June-August). This is a measure of stress on |
| | the secondary network region fed by the feeder |
| Average Shifted Load | The average shifted load factor of the feeder |
| Factor | when it is a member of the first five feeders |
| | (known as a band) in the shifted load matrix |
| | from a 2005 Jeopardy database. This is a |
| | measure of feeder electrical characteristics |
| Total Joints | Total joint count for the feeder, a measure of |
| | feeder length. |

The effect of Load Pocket Weight (the sum of the Load Pocket Weight for all transformers on each feeder) as a strong predictor of feeder outages was unexpected. While not being bound by any particular theory, it is believed that LPW is a good measure of stress, and that the state of the secondary (e.g. the existence of any trouble, like banks off and open mains, in the secondary network) is important to feeder performance.

The corresponding set of “impure feeders” were determined using “propensity score” matching. (See Rosenbaum, P. R. and Rubin, D. B., “The central Role of the Propensity Score in Observational Studies for Causal Effects,” Biometrika, Vol. 70, pp. 41-55 (1983), and D'Agostino, R B., Jr., “Tutorial in Biostatistics: Propensity Score Methods for Bias Reduction in the Comparison of a Treatment to a Non-Randomized Control Group,” Statist. Med., vol 17, pp. 2265-2281 (1988), both of which are hereby incorporated by reference in their entirety.

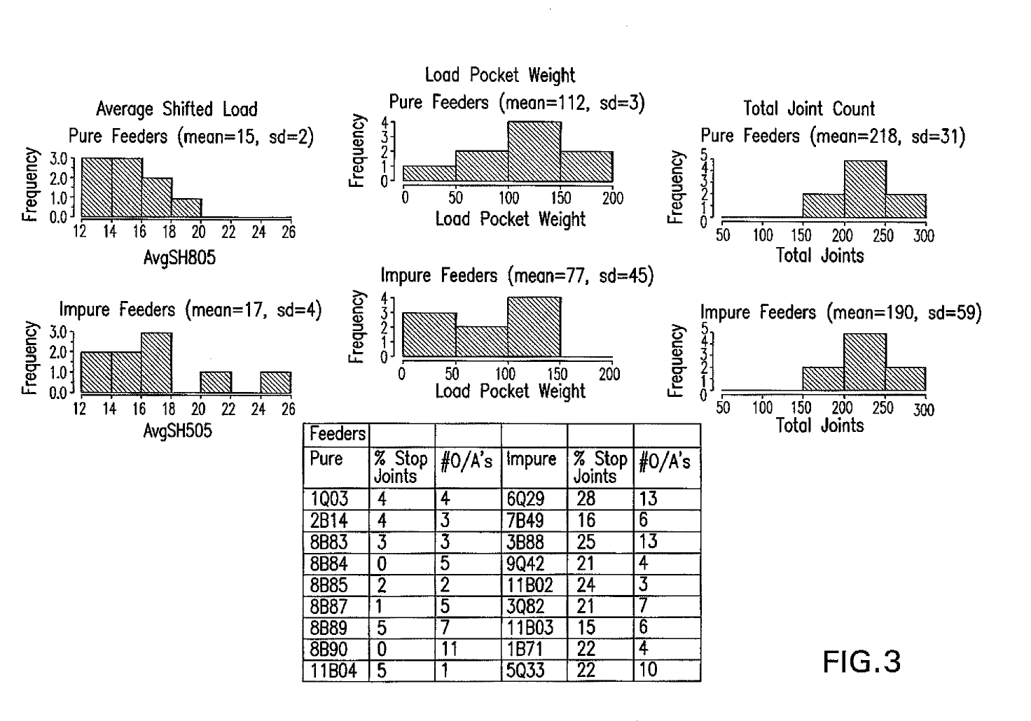

The propensity score is the probability of receiving treatment (here, purifying a feeder) and can be estimated using logistic regression. Two feeders that have the same or similar propensity score will have the same or similar distribution of attributes that were used to estimate the propensity scores (in this case, the attributes described above in Table 1). The distribution of the three attributes is shown in FIG. 3.

To test whether the pure feeders have significantly fewer failures than impure feeders, the number of outages for the pure feeders were compared to the matched, control group obtain via use of the propensity score methodology described above. This comparison was based on summer 2005 outage data for Brooklyn and Queens and linear regression. The estimated difference in true outages between pure and the matched, control group of impure feeders in Brooklyn and Queens was −1.1±0.4. In other words, the predicted effect in the number of summer outages obtained by converting an impure feeder into a pure feeder would have been 1.1 fewer O/A for a given pure feeder. The predicted decrease in number of summer trouble outages (defined as O/A+FOT+CIOA+OOE failures) obtained by purifying a feeder would have been −1.7±0.5, i.e., 1.7 fewer trouble outages per purified feeder. Both of these estimates were tested to be statistically significantly different from zero. Thus, it is highly unlikely that one would see such differences between pure and impure feeders just by chance, or due to unrelated phenomenon besides feeder purification.

As shown in FIG. 3, the number of O/A's from summer, 2001 through the summer, 2005 also shows a similar difference between the performance of the pure and impure control feeders. Over the 4-year period, there were 41 subsequent O/A's on the pure feeders, and 66 in the impure control group. Note that six of the feeders selected as “pure” are from the same network (Bay Ridge 8B). In 2000, reliability work was done on these feeders to “purify” them of stop joints. One poorly performing pure feeder (8B90 with 11 O/A's) caused that subset to show only a small difference between the 33 O/A's for the pure 8B feeders versus the 37 O/A's on its control group of impure feeders.

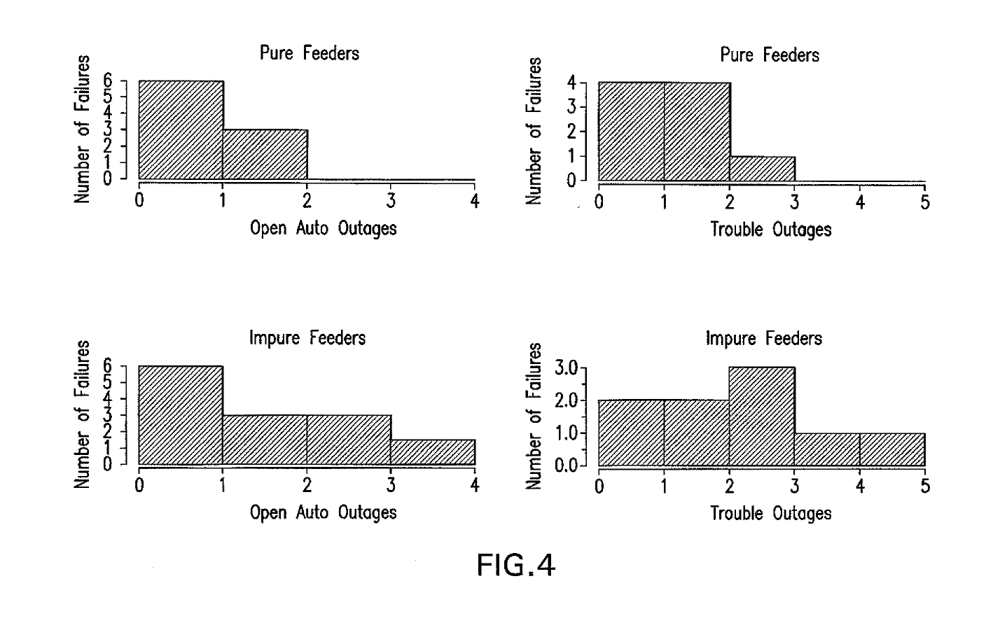

In FIG. 4, the statistical significance of the differences for the time interval summer, 2003 through summer 2005 is compared. For O/A outages only, the estimated decrease in number in number of true outages from purifying the feeder is −3.1 with standard error 1.2 over this 3 year period. For trouble outages, the estimated decrease in number of trouble outages from purifying a feeder is −4.8 with standard error 1.8. Both of these are indeed significantly different from zero.

In Manhattan, pure feeders seem to have slightly fewer outages than impure feeders, but these differences are not statistically significant. The predicted decrease in number of summer outages obtained by making an impure Manhattan feeder into a pure feeder is 0.2, with standard error 0.1. The predicted decrease in the number of summer outages obtained by purifying a Manhattan feeder is also 0.2, with standard error 0.1

The value of propensity scoring has been demonstrated for developing a “twin study” methodology addressing existing or proposed capital improvement strategies such as backbone feeder purification. By using the methods of the present application, a cost-benefit analysis can be performed, and it is determined that feeder purification efforts in Brooklyn and Queens provides increase value over purification efforts in Manhattan. Further, looking solely within the Brooklyn/Queens efforts, the costs of purifying the feeders can be compared to the costs incurred by the utility by feeder outages to help determine whether feeder purification efforts are justified.

The same methods used to compare the Brooklyn/Queens and Manhattan purification efforts can also be used in connection with further capital planning projects. The exact feeders to purify are to be determined, as well as the increase in reliability that would result on the corresponding networks. The reliability analysis can done using “Jeopardy,” or some other reliability evaluation tool such as, but not limited to, “Block Sim,” available from ReliaSoft Corporation, Tucson Ariz. Further details regarding business information and estimated cost per failure can be inserted into the above analysis to provide further insight into capital improvement planning. The capital cost required to obtain a pure feeder is to be evaluated against the operation & maintenance savings from fewer O/A's, and presumed lowered jeopardy to failure of networks in the summer months. This cost/benefit optimization can also be performed in view of regulatory considerations and reliability optimization considerations of where in the system to improve reliability to customers issues.

The operation of the methods of the present disclosure, including the propensity scoring method described in this Example, has wide applicability in transitioning to Condition Based Maintenance. For example, “twins” can be developed for all scheduled feeder work in order to build quantitative metrics to score the results of the maintenance so that performance can be improved.

It will be understood that the foregoing is only illustrative of the principles of the disclosed subject matter, and that various modifications can be made by those skilled in the art without departing from the scope and spirit thereof.

What is claimed is:

1. A method of quantitatively predicting an effectiveness of a proposed capital improvement project based on one or more previous capital improvement projects, said proposed capital improvement project and said one or more previous capital improvement projects each being representative of one or more physical assets and including one or more attributes, comprising:
(a) defining a first sample pool from said previous capital improvement project data in which said previous capital improvement project has been performed;
(b) defining a second sample in which said previous capital improvement project has not been performed, the second sample pool including one or more attribute values that are the same as, or similar to, said attribute values for said first sample pool;
(c) generating a performance metric for each of said first and second sample pools;
(d) comparing said performance metric from the first sample pool with said performance metric from the second sample pool to determine a net performance metric; and
(e) generating a prediction of effectiveness of said proposed capital improvement project concerning said at least one of said one or more physical assets based on said net performance metric.

2. The method of claim 1, wherein said proposed capital improvement project comprises an electrical grid improvement project and said one or more previous capital improvement projects comprise one or more previous electrical grid improvement projects.

3. The method of claim 2, wherein said at least one of said one or more attributes comprises one or more of a Load Pocket Weight (LPW) of an electrical feeder, a Shifted Load Factor of an electrical feeder, and a Total Number of Joints of an electrical feeder.

4. The method of claim 2, wherein said at least one of said one or more attributes comprises Load Pocket Weight (LPW) of an electrical feeder.

5. The method of claim 2, wherein said at least one of said one or more assets comprises a feeder.

6. The method of claim 2, wherein said generating said performance metric includes determining a frequency of outages in said electrical grid.

7. The method of claim 5, wherein said generating said performance metric comprises determining a frequency of open auto (O/A) feeder failure.

8. The method of claim 1, wherein said net performance metric is determined using at least one of: a propensity score, Levenshtein, Euclidean, Manhattan, Mahalanobis, Chebychev, Spearman, and Pearson Correlation coefficient

9. The method of claim 1, wherein said net performance metric is determined using a propensity score.

10. A system for of quantitatively predicting an effectiveness of a proposed capital improvement project based on one or more previous capital improvement projects, said proposed capital improvement project and said one or more previous capital improvement projects each being representative of one or more physical assets and including one or more attributes, comprising:
(a) one or more processors, each having respective communication interfaces to receive data concerning (1) said one or more previous capital improvement projects, including said one or more attribute values associated therewith, and (2) data representative of physical assets in which said one or more previous capital improvement projects has not been performed, and including attribute values associated therewith;
(b) one or more software applications, operatively coupled to the one or more processors, to
(1) define a first sample pool from said previous capital improvement project data in which said previous capital improvement projects has been performed, said first sample pool including one or more attribute values;
(2) define a second sample pool in which said previous capital improvement projects has not been performed, second sample pool including one or more attribute values that are the same as, or similar to, said attribute values for said first sample pool;
(3) generate a performance metric for each of said first and second sample pools;
(4) compare said performance metric from the first sample pool with said performance metric from the second sample pool to determine a net performance metric; and
(5) generate a prediction of effectiveness of said proposed capital improvement project concerning said at least one of said one or more physical assets based on said net performance metric; and
(c) a display, coupled to the one or more processors, for visually presenting said prediction of effectiveness.

11. The system of claim 9, wherein said proposed capital improvement project comprises an electrical grid improvement project and said one or more previous capital improvement projects comprise one or more previous electrical grid improvement projects.

12. The system of claim 9, wherein said at least one of said one or more attributes comprises one or more of a Load Pocket Weight (LPW) of an electrical feeder, a Shifted Load Factor of an electrical feeder, and a Total Number of Joints of an electrical feeder.

13. The system of claim 9, wherein said at least one of said one or more attributes comprises Load Pocket Weight (LPW) of an electrical feeder.

14. The system of claim 10, wherein said at least one of said one or more assets comprises a feeder.

15. The system of claim 10, wherein said generating said performance metric includes determining a frequency of outages in said electrical grid.

16. The system of claim 13, wherein said generating said performance metric comprises determining a frequency of open auto (O/A) feeder failure.

17. The system of claim 9, wherein said net performance metric is determined using at least one of: a propensity score, Levenshtein, Euclidean, Manhattan, Mahalanobis, Chebychev, Spearman, and Pearson Correlation coefficient

18. The system of claim 9, wherein said net performance metric is determined using a propensity score.

19. A computer-readable medium comprising at least one software component that, when executed, performs a method of quantitatively predicting an effectiveness of a proposed capital improvement project based on one or more previous capital improvement projects, said proposed capital improvement project and said one or more previous capital improvement projects each being representative of one or more physical assets and including one or more attributes, comprising:
(a) defining a first sample pool from said previous capital improvement project data in which said previous capital improvement project has been performed;
(b) defining a second sample in which said previous capital improvement project has not been performed, the second sample pool including one or more attribute values that are the same as, or similar to, said attribute values for said first sample pool;
(c) generating a performance metric for each of said first and second sample pools;
(d) comparing said performance metric from the first sample pool with said performance metric from the second sample pool to determine a net performance metric; and
(e) generating a prediction of effectiveness of said proposed capital improvement project concerning said at least one of said one or more physical assets based on said net performance metric.

20. The computer readable medium of claim 19, wherein said proposed capital improvement project comprises an electrical grid improvement project and said one or more previous capital improvement project comprise one or more previous electrical grid improvement projects.
